(19) United States
(12) Patent Application Publication
(10) Pub. No.: US 2007/0071218 A1
(43) Pub. Date: Mar. 29, 2007

(54) METHOD FOR IMPLEMENTING A CUSTOMIZED RING BACK TONE SERVICE AND SYSTEM THEREOF

(75) Inventor: Zhiming Zhang, Shenzhen (CN)

Correspondence Address: HARNESS, DICKEY & PIERCE, P.L.C., P.O. BOX 828, BLOOMFIELD HILLS, MI, 48303, US

(73) Assignee: Huawei Technologies Co., Ltd., Shenzhen (CN)

(21) Appl. No.: 11/470,362

(22) Filed: Sep. 6, 2006

Related U.S. Application Data
(63) Continuation of application No. PCT/CN06/00516, filed on Mar. 27, 2006.

(30) Foreign Application Priority Data
Apr. 4, 2005 (CN) 200510059966.3

(51) Int. Cl. H04M 7/00

(52) U.S. Cl. 379/221.09; 379/221.12

(57) ABSTRACT

A method for implementing a customized ring back tone service includes: upon receiving a call initiated by a caller, an SSP triggers the call to an SCP, and the SCP requests the SSP to report a detected alerting event of a callee and continue with the call handling; the SSP routes the call to the callee, reports the detected alerting event of the callee to the SCP, splits the call into a call segment associated with the caller and a call segment associated with the callee, and routes the call segment associated with the caller to an IP; the IP plays a ring back tone customized by the callee to the caller. The invention improves the implementation of the customized ring back tone service and ensures that no ring back tone will be played to the caller when the callee is not idle without modifying the existing protocols.

### CROSS-REFERENCE TO RELATED APPLICATIONS

This application is a continuation of International application Ser. No. PCT/CN2006/000516 filed on Mar. 27, 2006. This application claims the benefit of Chinese Application No. 200510059966.3 filed on Apr. 4, 2005. The disclosures of the above applications are incorporated herein by reference.

### FIELD

The present disclosure relates to Call Party Handling (CPH) technique in Intelligent network, and more particularly to a method for implementing a customized ring back tone service and a system thereof.

### BACKGROUND

The statements in this section merely provide background information related to the present disclosure and may not constitute prior art.

A customized ring back tone service refers to playing customized audio information to the caller during ringing at the callee side, rather than playing traditional dull ring back tones. This audio information, generally customized by the callee may be a song or any playable sound information, e.g. recording data, making the ring back tone variable and entertaining.

Customized ring back tones have become a popular fashion due to their strong characteristics of individualization. At present, there are many solutions to the implementation of a customized ring back tone service, e.g. the intelligent network solution, end office solution, and simultaneous ringing solution. In these solutions, however, devices of Service Switch Point do not support the CPH capabilities of INAP CS2 or CAMEL Phase 4. As a result, when the caller communicates with the callee, a device playing the customized ring back tone should serve as an intermediate switch device between the calling switch device and the called switch device to connect the voice channel between the caller and the callee.

After Service Switch Point (SSP) that supports the CPH capabilities of INAP CS2 or CAMEL Phase 4 has come into being, a technical solution in which CPH is adopted to implement a customized ring back tone service is put forward.

FIG. 1 is a message sequence chart illustrating the signalling interaction for implementing a customized ring back tone service using INAP CS2 CPH, which includes the steps of:

Step 101: Upon receiving a call from the caller, the SSP analyzes the called party number carried by the call, and if the callee has subscribed to a customized ring back tone service, the SSP will report to the Service Control Point (SCP) an Initial Detect Point (IDP) message containing the called party number to request the SCP to trigger a procedure of customized ring back tone service.

Steps 102˜103: Upon receiving the IDP message, the SCP triggers a procedure of customized ring back tone service, and issues to the SSP a Request Report Basic Call Status Model (BCSM) Event (RRBE) to instruct the SSP to report to the SCP through an Event Report BCSM (ERB) operation when the SSP detects a designated type of event during subsequent call-handling process. Moreover, the SCP issues to the SSP an Establishment Temporary Connection (ETC) operation to instruct the SSP to establish a temporary connection with an Intelligent Peripheral (IP) according to the address of the IP provided in the ETC message. Herein, the IP is the device for playing audio information to the caller.

Step 104: Upon receiving the RRBE and ETC operations issued by the SCP, the SSP monitors the designated event type in the RRBE operation, and establishes a temporary connection between the caller and the IP according to the designated IP address in the ETC operation, i.e., sending an Initial Address Message (IAM) to the IP to route the caller to the designated IP.

Steps 105˜106: Upon receiving the IAM, the designated IP sends an Assist Request Instruction (ARI) message to request the SCP to indicate the audio information that should be played to the caller currently and returns to the SSP an Address Complete Message (ACM).

Steps 107˜108: Upon receiving the ARI message, the SCP searches the audio information customized by the callee according to the called party number and the callee's subscription information of the customized ring back tone service, and sends a Play Announcement (PA) message to the designated IP, wherein the PA message contains the identity of the audio information subscribed by the callee. Upon receiving the PA message, the designated IP plays the appropriate audio information to the caller based on the identity of audio information.

Step 109: While the designated IP plays the customized ring back tone to the caller, the SCP issues to the SSP an Initial Call Attempt (ICA) operation, i.e., the SCP, serving as the network or as a designated caller, initiates a call to the designated callee. Furthermore, the SCP issues to the SSP an RRBE operation to instruct the SSP to report to the SCP through an ERB operation when detecting a designated event type during subsequent call-handling process. The SCP also issues to the SSP a Continue with Argument (CWA) operation to instruct the SSP to continue handling from the current suspending point.

Step 110: Upon receiving the ICA, RRBE, and CWA operations issued by the SCP, the SSP initiates a call to the callee, and after the callee answers, reports the detected off-hook event of the callee to the SCP through the ERB operation.

Steps 111˜113: Upon receiving the ERB operation reported by the SSP, the SCP issues to the SSP a Disconnect Forward Connection with Argument (DFCWA) operation to instruct the SSP to disconnect the voice channel between the caller and the IP, and issues to the SSP a Merge Call Segments (MgC) operation to instruct the SSP to merge the call segment associated with the caller and the call segment associated with the callee. The SCP also issues to the SSP a CWA operation to instruct the SSP to continue handling from the current suspending point.

Steps 114˜115: Upon receiving the DFCWA, MgC and CWA operations issued by the SCP, the SSP disconnects the voice channel between the caller and the IP, and merges the segment associated with the caller and the segment associated with the callee to make the caller and the callee communicate with each other. When detecting that the call is released due to on-hook by either of the caller and the callee, the SSP reports the detected on-hook event to the SCP through an ERB operation. Upon receiving the event reported by SSP through the ERB operation, the SCP issues to the SSP a Release Call (RC) message to instruct the SSP to release the call entirely, and then the SSP releases the call entirely upon receiving the RC message issued by the SCP.

The signalling interaction for implementing a customized ring back tone service using CPH capabilities of CAMEL Phase 4 is basically the same as that shown in FIG. 1.

As can be seen from the above description of implementing the customized ring back tone service, the customized ring back tone is directly played to the caller without determining the current status of the callee.

### SUMMARY

A method for implementing a customized ring back tone service includes:

upon receiving a call initiated by a caller to a callee, a Service Switch Point (SSP) triggers the call to a Service Control Point (SCP), and the SCP instructs the SSP to report a detected alerting event of the callee and continue with the call handling;

the SSP routes the call to the callee, reports the detected alerting event of the callee to the SCP, splits the call into a call segment associated with the caller and a call segment associated with the callee according to instruction from the SCP, and routes the call segment associated with the caller to an Intelligent peripheral (IP) according to an IP address provided by the SCP;

the IP plays a ring back tone customized by the callee to the caller.

A method for implementing a customized ring back tone service includes:

upon receiving a call initiated by a caller to a callee, triggering, by a Service Switch Point (SSP), the call to a Service Control Point (SCP), and requesting the SSP, by the SCP, to report a detected alerting event, off-hook event or on-hook event of the callee and continue with the call handling;

routing, by the SSP, the call to the callee, reporting the detected alerting event of the callee to the SCP, splitting the call into a call segment associated with the caller and a call segment associated with the callee according to an instruction from the SCP, and routing the call segment associated with the caller to an Intelligent Peripheral (IP) according to the IP address provided by the SCP;

playing, by the IP, a ring back tone customized by the callee to the caller;

reporting, by the SSP, to the SCP if an off-hook event of the callee is detected, disconnecting the voice channel between the call segment associated with the caller and the IP according to an instruction from the SCP, and merging the call segment associated with the caller with the call segment associated with the callee, making the caller communicate with the callee;

reporting, by the SSP, to the SCP if an on-hook event is detected, and releasing the call according to an instruction from the SCP.

A system for implementing a customized ring back tone service includes:

a Service Switch Point (SSP), for triggering a call initiated by a caller to a Service Control Point (SCP); routing the call to a callee, reporting a detected alerting event of the callee to the SCP, splitting the call into a call segment associated with the caller and a call segment associated with the callee according to an instruction from the SCP; and routing the call segment associated with the caller to an Intelligent Peripheral (IP) according to the IP address provided by the SCP;

the SCP, for requesting the SSP to report the detected alerting event of the callee and continue with the call handling;

the IP, for playing a ring back tone customized by the callee to the caller.

A system for implementing a customized ring back tone service includes:

a Service Switch Point (SSP), for triggering a call initiated by a caller to a Service Control Point (SCP); routing the call to a callee, reporting a detected alerting event of the callee, splitting the call into a call segment associated with the caller and a call segment associated with the callee according to an instruction from the SCP; and routing the call segment associated with the caller to an Intelligent Peripheral (IP) according to the IP address provided by the SCP; reporting to the SCP if an off-hook event of the callee is detected, disconnecting the voice channel between the call segment associated with the caller and the IP according to an instruction from the SCP, and merging the call segment associated with the caller with the call segment associated with the callee, making the caller communicate with the callee; reporting to the SCP if an on-hook event is detected, and releasing the call according to an instruction from the SCP;

the SCP, for requesting the SSP to report the detected alerting event, off-hook event or on-hook event of the callee and continue with the call handling;

the IP, for playing a ring back tone customized by the callee to the caller.

As seen from the above mentioned solution, the SSP triggers a control relation to the SCP upon receiving a call initiated by the caller to the callee. The SCP instructs the SSP to report to the SCP when determining that the callee is in an idle state. When learning that the callee is in an idle state, the SCP instructs the SSP to split the current call into two call segments; one is associated with the caller and the other is associated with the callee, and instructs the SSP to route the call segment associated with the caller to the IP so that the IP could play the customized ring back tone customized by the callee to the caller. The SSP reports to the SCP when detecting the off-hook of the callee, disconnects the voice channel between the caller and the IP according to the instruction from the SCP, and merges the call segment associated with the caller with the call segment associated with the callee to get the caller and the callee communicating with each other. Therefore, in accordance with the method, the customized ring back tone will be played to the caller only when the callee is idle, giving a reasonable experience for the caller. In addition, there is no ICA operation in the signalling interaction in accordance with this method, which effectively avoids re-triggering of the customized ring back tone service. Thus there is no need to modify the ICA operation to avoid re-triggering of customized ring back tone service, which makes the conformity of the implementation with the specifications higher and the inter-working of communication networks easier.

In addition, a SplitLeg (SL) operation is adopted in this invention to replace the operations of ICA, RRBE and CWA in the prior art, which simplifies the implementation of customized ring back tone service and improves the efficiency of the implementation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a message sequence chart illustrating the signalling interaction for implementing a customized ring back tone service using INAP CS2 CPH.

FIG. 2 is a flowchart of implementing a customized ring back tone service using INAP CS2 CPH in accordance with an embodiment of this invention.

FIG. 3 is a message sequence chart illustrating the signalling interaction using INAP CS2 CPH in accordance with an embodiment of this invention.

FIG. 4 is a message sequence chart illustrating the signalling interaction using CAMEL Phase 4 CPH in accordance with another embodiment of this invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

This invention is hereinafter further described in detail with reference to the accompanying drawings as well as embodiments so as to make the technical solution and merits thereof more apparent.

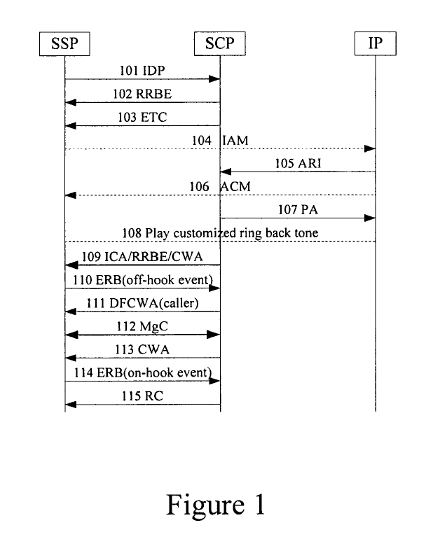

As mentioned above, in prior art, the customized ring back tone is directly played to the caller without determining the current status of the callee. In fact, if the callee is in a non-idle status, such as the occupied status, the current call can not be routed to the callee. In this way, the played customized ring back tone becomes wrong information provided for the caller. It is also likely that, when the callee is in a non-idle status, such as occupied status, the IP has played the customized ring back tone to the caller, and when the SSP fails to route the call to the callee, it plays an appropriate tone of failure prompt to the caller, which leads to inconsecutive tones that the caller hears. In addition, in order to prevent the ICA operation in Step 109 shown in FIG. 1 from re-triggering the intelligent service, it is necessary to extend the ICA operation of the existing INAP protocol. The modification to the ICA operation, however, is not involved in a standard protocol.

In accordance with an embodiment of this invention, the SSP triggers a control relation at the SCP upon receiving a call initiated by the caller to the callee, the SCP instructs the SSP to report to the SCP when determining that the callee is in an idle status, and when learning that the callee is in an idle status, the SCP instructs the SSP to split the current call into a call segment associated with the caller and a call segment associated with the callee and route the call segment associated with the caller to the IP so that the IP could play the ring back tone customized by the callee to the caller; the SSP reports to the SCP when detecting an off-hook of the callee, disconnects the voice channel between the caller and the IP according to the instruction from the SCP, and merges the call segment associated with the caller and the call segment associated with the callee, making the caller and the callee communicate with each other.

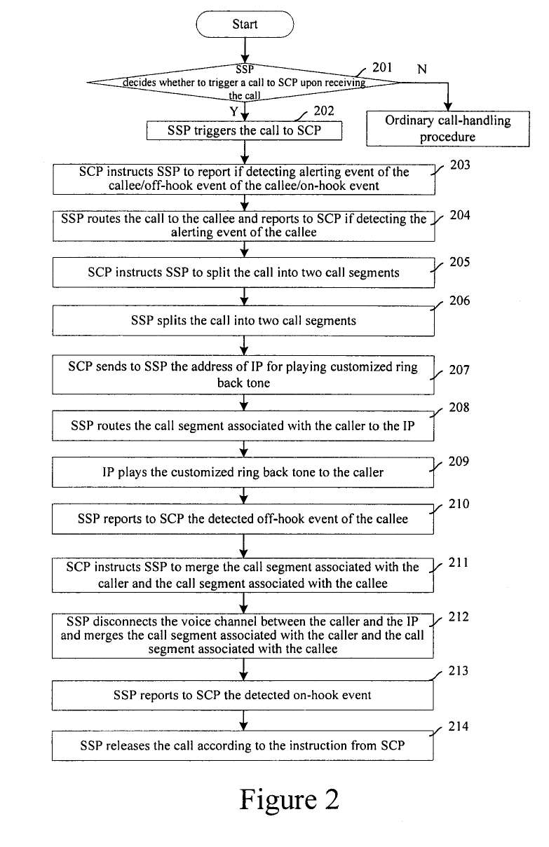

FIG. 2 is a flowchart for implementing the customized ring back tone service using INAP CS2 CPH in accordance with an embodiment of this invention. As shown in FIG. 2, the implementation of customized ring back tone service using INAP CS2 CPH includes the steps of:

Step 201: Upon receiving a call initiated by the caller to the callee, the SSP decides according to the called party number carried by the call whether the callee has subscribed to the customized ring back tone service. If the callee has subscribed to the service, proceed to Step 202; otherwise, perform the ordinary call procedure and put through the call to the callee.

Steps 202˜203: The SSP triggers an action at the SCP, and the SCP instructs the SSP to report to the SCP when detecting an alerting event of the callee, or an off-hook event of the callee, or an on-hook event.

Steps 204˜206: The SSP routes the call to the callee and when determining that the callee is idle, i.e., detecting that it is ringing at the callee side, reports to the SCP the detected alerting event of the callee. The SCP, based on the alerting event of the callee, instructs the SSP to split the current call into two call segments. The SSP, according to the instruction from the SCP, splits the current call into a call segment associated with the caller and a call segment associated with the callee.

Steps 207˜209: The SCP sends to the SSP the address of the IP for playing the customized ring back tone. The SSP, according to the received IP address, routes the call segment associated with the caller to the IP of which the address has been received. And the IP plays the ring back tone customized by the callee to the caller.

Here, the IP may acquire, by interaction with the SCP, the audio information customized by the callee who has subscribed to the customized ring back tone service, and play the corresponding audio information to the caller based on the acquired audio information. Alternatively, the IP may, according to the called party number provided by the SSP or SCP as well as the relationship between the self-stored called party number and the ring back tone customized by the callee, search the identity of the corresponding audio information, and play the appropriate audio information to the caller.

Steps 210˜212: The SSP reports to the SCP the detected off-hook event of the callee, the SCP instructs the SSP to merge the call segment associated with the caller and the call segment associated with the callee. The SSP, according to the instruction from the SCP, disconnects the voice channel between the caller and the IP, and merges the call segment associated with the caller and the call segment associated with the callee, making the caller and the callee communicate with each other.

Steps 213˜214: When either of the caller or the callee on-hook initiates the call release, the SSP reports to the SCP the detected on-hook event. The SCP instructs the SSP to release the call. The SSP releases the call entirely according to the instruction from the SCP.

Although the flowchart in FIG. 2 takes the INAP CS2 CPH used in a fixed phone network as an example, it is understood that the flowchart in FIG. 2 is applicable to a mobile communication network as well.

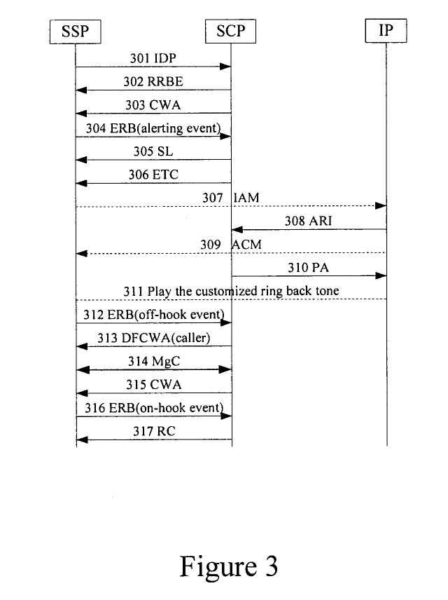

FIG. 3 is a schematic diagram illustrating the signalling interaction using INAP CS2 CPH in accordance with an embodiment of this invention. As shown in FIG. 3, the signalling interaction for implementing the customized ring back tone service in a fixed phone network using INAP CS2 CPH comprises the steps of:

Step 301: Upon receiving a call initiated by the caller, the SSP analyzes the called party number carried by the call, decides that the callee has subscribed to the customized ring back tone service, and reports to the SCP an IDP message containing the called party number to instruct the SCP to trigger a procedure of customized ring back tone service.

Steps 302˜303: Upon receiving the IDP message, the SCP triggers a procedure of customized ring back tone service, issues to the SSP an RRBE operation, and instructs the SSP to report to the SCP through an ERB operation when detecting a designated event type during subsequent call-handling process. Furthermore, the SCP issues to the SSP a CWA operation to instruct the SSP to continue handling from the current suspension point. In the RRBE operation, the designated event type can be set as the alerting event of the callee, the off-hook event of the callee, or the on-hook event of the callee.

Step 304: Upon receiving the RRBE and CWA operations issued by the SCP, the SSP initiates a call to the callee, and reports to the SCP the detected alerting event of the callee through an ERB operation when determining that the callee is idle, i.e., there is ringing at the callee side.

Steps 305˜306: Upon receiving the ERB operation reported by the SSP, the SCP sends an SL message to the SSP, and instructs the SSP to split the current call into two call segments. Moreover, the SCP issues an ETC operation to the SSP, requesting the SSP to establish a temporary connection according to the provided IP address. Herein, the IP is the device for playing the audio information to the caller.

Step 307: Upon receiving the SL message and ETC operation issued by the SCP, the SSP splits the current call into a call segment associated with the caller and a call segment associated with the callee, and, according to the IP address designated in the ETC operation, routes the call segment associated with the caller to the designated IP, i.e., sending an IAM to the designated IP, to establish a temporary connection with the IP.

Steps 308˜309: Upon receiving the IAM, the designated IP sends to the SCP an ARI message, requesting the SCP to indicate the audio information that should be played to the caller currently. And the IP returns an ACM to the SSP.

Steps 310˜311: Upon receiving the ARI message, the SCP, based on the called party number and the callee's subscription information of the customized ring back tone service, searches the audio information customized by the callee, and sends a PA message to the IP. The PA message contains the identity of the audio information customized by the callee. Upon receiving the PA message, the IP plays the appropriate audio information to the caller based on the identity of audio information.

Steps 312˜315: After the callee answers the call, the SSP reports the detected off-hook event of the callee to the SCP through an ERB operation. Upon receiving the ERB operation reported by the SSP, the SCP issues to the SSP a DFCWA operation, instructing the SSP to disconnect the voice channel between the caller and the IP. Moreover, the SCP issues to the SSP an MgC operation, instructing the SSP to merge the call segment associated with the caller and the call segment associated with the callee. The SCP also issues a CWA operation to the SSP, instructing the SSP to continue handling from the current suspending point.

Steps 316˜317: Upon receiving the DFCWA, MgC and CWA operations issued by the SCP, the SSP disconnects the voice channel between the caller and the IP, and merges the call segment associated with the caller and the call segment associated with the callee, making the caller and the callee communicate with each other. When either of the caller on-hook or the callee on-hook occurs, the SSP reports the detected on-hook event to the SCP through an ERB operation. Upon receiving the ERB operation reported by the SSP, the SCP issues to the SSP an RC message to instruct the SSP to release the call entirely, and the SSP releases the call entirely upon receiving the RC message issued by the SCP.

As each SSP in a fixed telephone network has saved the information associated with subscribers, the SSP involved in FIG. 3 may be the called SSP, thus the called SSP is able to acquire, according to the self-saved information, the subscription information of the callee.

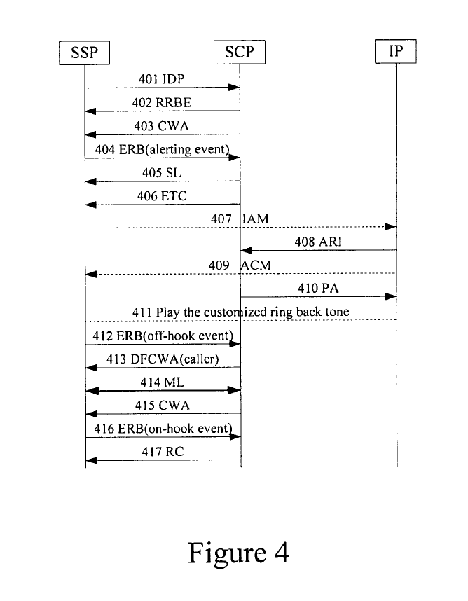

FIG. 4 is a schematic diagram illustrating the signalling interaction using CAMEL Phase 4 CPH in accordance with another embodiment of this invention. As shown in FIG. 4, the signalling interaction for implementing the customized ring back tone service in a mobile communication network using CAMEL Phase 4 CPH comprises the steps of:

Steps 401˜413 are the same as Steps 301˜313.

The difference between Step 414 and Step 314 is: in Step 414, the SCP instructs the SSP to merge the call segment associated with the caller and the call segment associated with callee by issuing to the SSP a Move Leg (ML) operation.

Steps 415˜417 are the same as Steps 315˜317.

Likewise, the signalling interaction shown in FIG. 4 is not only applicable to PSTN, but also to mobile communication networks as well.

In a mobile communication network, since the calling SSP may acquire the relevant information of the callee by interaction with the called Home Location Register (HLR) during the call-routing process, the SSP involved in FIG. 4 may be the calling SSP, and before Step 401, the calling SSP may acquire the subscription information of the callee by interaction with the called HLR to decide whether to trigger an action at the SCP. The process of acquiring the subscription information of the callee from the HLR may be: requesting the HLR to provide the subscription information of the callee through the procedure of requesting the called MSRN from the HLR; or requesting the HLR to provide the subscription information of the callee through an independent process of message interaction.

The above mentioned SSP may be a switch in a fixed telephone network, e.g., Integrated Services Digital Network (ISDN) or Public Switched Telephone Network (PSTN), and may be a Mobile Switch Centre (MSC) or a MSCNisited Location Register (VLR) in a mobile communication network.

The basic implementing procedure of a customized ring back tone service is described while other procedures related with a call, e.g., the accounting procedure, and other events that the SCP requests the SSP to report, e.g., an event of abnormal interruption of communications, are not described in detail because they are irrelevant to the implementation of the customized ring back tone service provided by this invention and are widely known by those skilled in the art.

To sum up, the foregoing is only the preferred embodiments of this invention and is not intended to limit the protection scope thereof.

What is claimed is:

1. A method for implementing a customized ring back tone service, comprising:
upon receiving a call initiated by a caller to a callee, triggering, by a Service Switch Point (SSP), the call to a Service Control Point (SCP), and requesting the SSP, by the SCP, to report a detected alerting event of the callee and continue with the call handling;
routing, by the SSP, the call to the callee, reporting the detected alerting event of the callee to the SCP, splitting the call into a call segment associated with the caller and a call segment associated with the callee according to an instruction from the SCP, and routing the call segment associated with the caller to an Intelligent Peripheral (IP) according to the IP address provided by the SCP;
playing, by the IP, a ring back tone customized by the callee to the caller.

2. The method according to claim 1, further comprising:
requesting the SSP, by the SCP, to report a detected off-hook event of the callee;
after playing, by the IP, a ring back tone to the caller, reporting, by the SSP, the detected off-hook event of the callee to the SCP, disconnecting the voice channel between the call segment associated with the caller and the IP according to an instruction from the SCP, and merging the call segment associated with the caller with the call segment associated with the callee, making the caller communicate with the callee.

3. The method according to claim 2, further comprising:
requesting the SSP, by the SCP, to report if an on-hook event is detected;
reporting to the SCP, by the SSP, if the on-hook event is detected, and releasing the call according to an instruction from the SCP.

4. The method according to claim 2, wherein the SCP instructs the SSP to merge the call segment associated with the caller with the call segment associated with the callee through a Merge Call (MgC) operation or a Move Leg (ML) operation.

5. The method according to claims 1, wherein the SCP instructs the SSP to report through issuing to the SSP a Request Report BCSM (Basic Call Status Model) Event (RRBE) operation.

6. The method according to claims 1, wherein the SSP reporting the detected event to the SCP through an Event Request BCSM (ERB) operation.

7. The method according to claim 1, further comprising:
deciding, by the SSP, according to a called party number whether the callee has subscribed to the customized ring back tone service, if the callee has subscribed to the service, triggering by the SSP the call to the SCP; otherwise, routing by the SSP the call directly to the callee.

8. The method according to claim 1, further comprising:
after routing by the SSP the call segment associated with the caller to the IP, requesting by the IP to the SCP current audio information of the customized ring back tone that needs to be played, and based on the called party number and the callee's subscription information of the customized ring back tone service, searching by the SCP an identity of the audio information and providing the identity of the audio information for the IP;
playing by the IP a ring back tone to the caller comprises: playing by the IP the customized ring back tone to the caller according to the identity of audio information.

9. The method according to claim 1, further comprising:
after routing by the SSP the call segment associated with the caller to the IP, searching by the IP an identity of the audio information according to the called party number and saved customized ring back tone customized by the callee;
playing by the IP a ring back tone to the caller comprises: playing by the IP the customized ring back tone to the caller according to the identity of audio information that has been found.

10. The method according to claim 1, wherein instructing by the SCP the SSP to split the current call into a call segment associated with the caller and a call segment associated with the callee is implemented through a Split Leg (SL) message.

11. The method according to claim 1, wherein the IP address is carried in an Establishment Temporary Connection (ETC) operation issued to the SSP by the SCP.

12. The method according to claims 2, wherein the SCP instructs the SSP to report through issuing to the SSP a RRBE operation.

13. The method according to claims 3, wherein the SCP instructs the SSP to report through issuing to the SSP a RRBE operation.

14. The method according to claims 2, wherein the SSP reporting the detected event to the SCP through an ERB operation.

15. The method according to claims 3, wherein the SSP reporting the detected event to the SCP through an ERB operation.

16. A method for implementing a customized ring back tone service, comprising:
upon receiving a call initiated by a caller to a callee, triggering, by a Service Switch Point (SSP), the call to a Service Control Point (SCP), and requesting the SSP, by the SCP, to report a detected alerting event of the callee, off-hook event of the callee or on-hook event of any one of the caller and the callee and continue with the call handling;
routing, by the SSP, the call to the callee, reporting the detected alerting event of the callee to the SCP, splitting the call into a call segment associated with the caller and a call segment associated with the callee according to an instruction from the SCP, and routing the call segment associated with the caller to an Intelligent Peripheral (IP) according to the IP address provided by the SCP;
playing, by the IP, a ring back tone customized by the callee to the caller;
reporting, by the SSP, to the SCP if an off-hook event of the callee is detected, disconnecting the voice channel between the call segment associated with the caller and the IP according to an instruction from the SCP, and merging the call segment associated with the caller with the call segment associated with the callee, making the caller communicate with the callee;
reporting, by the SSP, to the SCP if an on-hook event of any one of the caller and the callee is detected, and releasing the call according to an instruction from the SCP.

17. The method according to claim 16, wherein the step of playing by the IP a ring back tone customized by the callee to the caller comprises:
requesting, by the IP, to the SCP current audio information of the customized ring back tone that needs to be played, and based on the called party number and the callee's subscription information of the customized ring back tone service, searching, by the SCP, an identity of the audio information and providing the identity of the audio information for the IP;
playing, by the IP, the customized ring back tone to the caller according to the identity of audio information.

18. The method according to claim 16, wherein the step of playing by the IP a ring back tone customized by the callee to the caller comprises:
searching, by the IP, an identity of the audio information according to the called party number and saved customized ring back tone customized by the callee;
playing by the IP a ring back tone to the caller comprises: playing, by the IP, the customized ring back tone to the caller according to the identity of audio information that has been found.

19. A system for implementing a customized ring back tone service, comprising:
a Service Switch Point (SSP), for triggering a call initiated by a caller to a Service Control Point (SCP); routing the call to a callee, reporting a detected alerting event of the callee to the SCP, splitting the call into a call segment associated with the caller and a call segment associated with the callee according to an instruction from the SCP; and routing the call segment associated with the caller to an Intelligent Peripheral (IP) according to the IP address provided by the SCP;
the SCP, for requesting the SSP to report the detected alerting event of the callee and continue with the call handling;
the IP, for playing a ring back tone customized by the callee to the caller.

20. A system for implementing a customized ring back tone service, comprising:
a Service Switch Point (SSP), for triggering a call initiated by a caller to a Service Control Point (SCP); routing the call to a callee, reporting a detected alerting event of the callee, splitting the call into a call segment associated with the caller and a call segment associated with the callee according to an instruction from the SCP; and routing the call segment associated with the caller to an Intelligent Peripheral (IP) according to the IP address provided by the SCP; reporting to the SCP if an off-hook event of the callee is detected, disconnecting the voice channel between the call segment associated with the caller and the IP according to an instruction from the SCP, and merging the call segment associated with the caller with the call segment associated with the callee, making the caller communicate with the callee; reporting to the SCP if an on-hook event of any one of the caller and the callee is detected, and releasing the call according to an instruction from the SCP;
the SCP, for requesting the SSP to report the detected alerting event of the callee, off-hook event of the callee or on-hook event of any one of the caller and the callee and continue with the call handling;
the IP, for playing a ring back tone customized by the callee to the caller.
